(19) United States
(12) Patent Application Publication
(10) Pub. No.: US 2009/0161016 A1
(43) Pub. Date: Jun. 25, 2009

(54) Run-Time Selection Of Video Algorithms

(76) Inventors: Daniel W. Wong, Cupertino, CA (US); David I.J. Glen, Toronto (CA)

Correspondence Address: COURTNEY STANIFORD & GREGORY LLP, P.O. BOX 9686, SAN JOSE, CA, 95157, US

(21) Appl. No.: 11/962,832

(22) Filed: Dec. 21, 2007

(51) Int. Cl. H04N 5/00

(52) U.S. Cl. 348/607; 348/E05.001

(57) ABSTRACT

Most often a pleasing video scene includes a few objects of great interest shown in front of a relatively uninteresting background. These pleasing scenes can be displayed with greater clarity and realism when the most computing intensive filter algorithms are used for images or parts of images of greatest interest. Run-time selection of algorithms used in particular frames or regions of a frame optimizes the use of filter computation resources.

### TECHNICAL FIELD

The disclosure is related to digital video processing.

### BACKGROUND

Digital video processing generally refers to the transformation of video through filter operations such as scaling, de-interlacing, sampling, noise reduction, restoration, and compression. For example, de-interlacing is the process of converting video from the interlaced scan format to the progressive scan format.

Interlaced video is recorded in alternating sets of lines: odd-numbered lines are scanned, then even-numbered lines are scanned, then the odd-numbered lines are scanned again, and so on. One set of odd or even lines is referred to as a field and a consecutive pairing of two fields of opposite parity is called a frame. In progressive scan video each frame is scanned in its entirety. Thus, interlaced video captures twice as many fields per second as progressive video does when both operate at the same number of frames per second.

De-interlacing filters make use of motion detection algorithms to compensate for motion of objects in a video image that occurs between interlaced fields. De-interlacing filters may involve purely spatial methods, spatial-temporal algorithms, algorithms including edge reconstruction and others.

Scaling is the process of adapting video for display by devices having different numbers of pixels per frame than the original signal. Scaling filters can range in complexity from simple bilinear interpolations to non-linear, content adaptive methods.

A digital video filter may be designed to use one of several possible algorithms to carry out the filter operation. The choice of which algorithm to use in a particular filter depends, in part, on the computing power available to attack the problem.

Digital filtering operations may be performed by a graphics processing unit (GPU) or specialized hardware logic or other microprocessor hardware. The processor operates on the digital representation of video images.

In the case of a 60 Hz video frame rate, each frame is redrawn every 16.7 ms. The number of pixels per frame varies widely depending on the resolution of the display system. The computing power available to perform digital video filtering therefore depends on the number of processor clock cycles per pixel per filtering operation. Faster processors run more clock cycles per unit time.

In traditional digital video processing systems, the choice of which algorithm to use for each filter is fixed. The choice is based on known quantities such as processor speed and perhaps display resolution, and on engineering estimates of worst-case scenarios for the difficulty of the filtering job. To prevent a filtering system from failing for lack of processing speed, filter algorithms are selected that can always be completed by the processor in the time available.

Use of a filter that runs reliably in worst-case scenarios provides less than optimal performance for typical video frames. What is needed is a method for digital video filtering that provides better performance than fixed-algorithm methods.

### BRIEF DESCRIPTION OF THE DRAWINGS

The drawings are heuristic for clarity.

FIG. 1 is a flow chart for a digital video processing method.

FIG. 2 is a flow chart for a digital video processing method with pre-screening and algorithm selection.

FIG. 3 is a table of pre-screening methods and algorithms for de-interlacing and scaling filters.

FIGS. 4A and 4B show whole frame and tiled sub-frames respectively.

### DETAILED DESCRIPTION

Digital video filter operations such as scaling, de-interlacing, sampling, noise reduction, restoration, compression, and the like are often performed by graphics processing units or other processor chips. The processor executes programs which implement algorithms to perform the desired filter operation.

Pixels in an image carry visual information. However, not every pixel conveys the same amount of information in the process. Some pixels in a frame contribute more than others and they deserve more attention in video quality related operations.

The images in video programs are most often scenes of interest to human viewers; e.g. scenes containing people, natural landscapes, buildings, etc. (Images not of interest to most viewers include test patterns, for example.) Video programs that people want to watch rarely include scenes that use the maximum computing power of processors running traditional digital filters. That maximum effort is held in reserve for the occasional scenes that require it.

Most often a pleasing video scene includes a few objects of great interest, such as faces, cars, or perhaps a helicopter, shown in front of a relatively uninteresting background. These pleasing scenes can be displayed with greater clarity and realism when the most computing intensive filter algorithms are used for images or parts of images of greatest interest.

A system and method are described herein which allow a video processor to select on the fly which filter algorithm to run on a frame by frame basis, or even for different regions in a single frame. Computing resources are devoted to sophisticated filter algorithms whenever possible while simpler, less computationally intensive algorithms are used for frames that would otherwise overwhelm the available computing power.

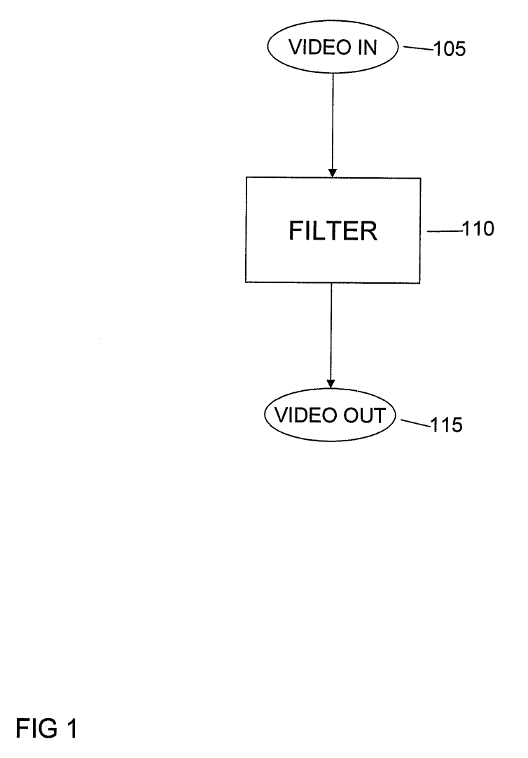

FIG. 1 is a flow chart for a digital video processing method. In the figure, input video signal 105 is processed by digital video filter 110 leading to output video signal 115. This is the basic flow chart for a digital video processing method in which the algorithm used by a processor is fixed for the filter operation. The filter algorithm does not change depending on the visual content represented by the video input signal.

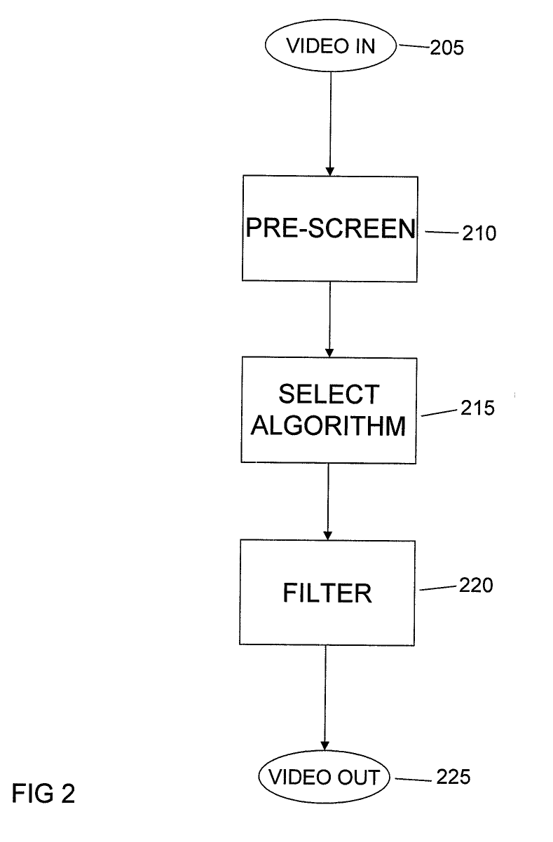

FIG. 2 is a flow chart for a digital video processing method with pre-screening and algorithm selection. In FIG. 2, input video signal 205 is pre-screened 210, an appropriate filter algorithm is selected 215 based on the results of the pre-screening operation, a digital video filter 220 using the selected algorithm processes the video signal, leading finally to the output video signal 225.

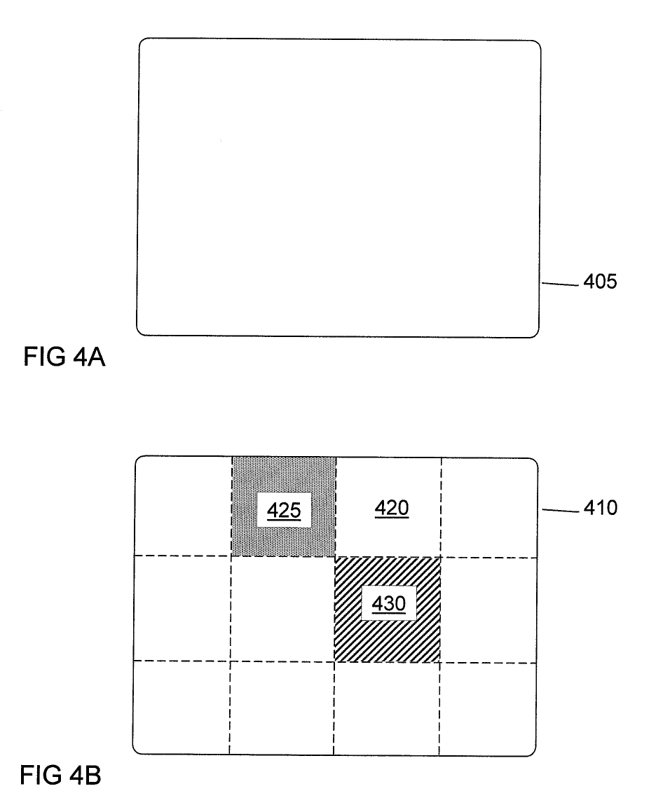

Pre-screening 210 may be performed on an entire video frame or in a region within a frame as described in connection with FIGS. 4A and 4B. The method of FIG. 2 may be implemented in a graphics processing unit or other microprocessor chip. The method can be performed entirely in software or in a combination of hardware and software. For example, accumulators used in pre-screening can be implemented in dedicated hardware blocks in a graphics processing unit as can numerical logic units used for executing various algorithms.

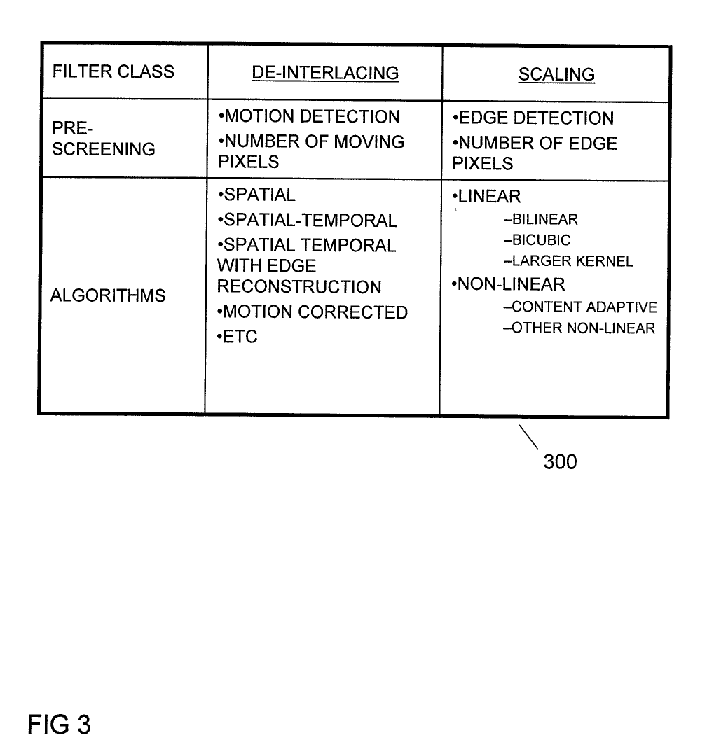

FIG. 3 is a table 300 of some exemplary pre-screening methods and algorithms for de-interlacing and scaling filters. Pre-screening for de-interlacing comprises the use of motion detection methods and counting the number of pixels that move between successive fields of an interlaced frame. The number of pixels in motion determines which of several possible de-interlacing algorithms is run for a particular frame. When large numbers of pixels are in motion, less computationally intensive algorithms are selected; when small numbers of pixels are in motion, more computationally intensive algorithms are selected. The use of computational resources in the video processor is therefore optimized.

Possible de-interlacing algorithms, in order of increasing computational requirements, include: spatial algorithms, spatial-temporal algorithms, spatial-temporal algorithms with edge reconstruction, and motion-corrected algorithms.

Pre-screening for scaling comprises the use of edge detection methods and counting the number of edge pixels in a frame The number of edge pixels determines which of several possible scaling algorithms is run for a particular frame. When a high proportion of pixels are edge pixels, less computationally intensive algorithms are selected; when small numbers of pixels are edge pixels, more computationally intensive algorithms are selected. The use of computational resources in the video processor is therefore optimized.

Possible scaling algorithms, in order of increasing computational requirements, include: linear algorithms such as bilinear and bicubic scaling, linear algorithms using larger kernels, non-linear content adaptive scaling, and algorithms that involve mixture of linear and non-linear scaling in both spatial and temporal domains.

The methods illustrated in FIGS. 2 and 3 may be applied to whole or tiled video frames. FIGS. 4A and 4B show whole and tiled frames respectively. In FIG. 4A, rectangle 405 represents a complete video frame. Video content is omitted for simplicity. Digital video processing methods that include run-time selection of filtering algorithms may be applied to whole video frames on a frame-by-frame basis.

Different algorithms for whole frames are selected as video scenes change over time, for example from an image of Tiger Woods against a solid green background to an image of a gallery of spectators containing hundreds of faces. Frame-by-frame algorithm selection enables the use of computationally intensive algorithms in a scene of Mr. Woods so that his features are as clear and lifelike as possible. The solid green background takes very little processing time. Less computationally intensive algorithms are used in a scene of the gallery as the multitude of features uses up processor resources quickly and most viewers are not particularly interested in the details of the gallery anyway. Without the ability to select a filter algorithm frame-by-frame, the less intensive algorithm would have to be used not only on the gallery, but also for Mr. Woods. His face would not be as vivid as it could be.

The advantages of run-time algorithm selection are further increased by applying the method to individual tiles in a video frame. In FIG. 4B video frame 410 is divided into twelve tiles including tiles 420, 425 and 430. Of course, the number of tiles into which frame 410 is divided is a matter of engineering convenience. Division into a greater or smaller number of tiles does not change the principle of run-time algorithm selection. Furthermore, the number of tiles per frame can vary from frame to frame depending on how many distinct regions of interest fall within a given frame. Further still, tiles in a frame need not be rectangular nor all of the same size or shape. The only limitation on tiles is that they define regions of a frame to which a particular filter algorithm is applied.

In FIG. 4B tile 425 represents a region in which a particular filter algorithm is applied that is not the same as that used in adjacent regions. Similarly, a different filter algorithm is used for the region defined by tile 430. In the rest of the frame, including tile 420, a third algorithm is used. A situation such as that illustrated by FIG. 4B could arise in a case where most of a video frame would not benefit from a computationally intensive algorithm (e.g. tile 420 and other non-shaded areas), but two regions (tiles 425 and 430) represent exceptions. For example, tiles 425 and 430 might cover areas containing relatively large numbers of moving or edge pixels that would benefit from computationally intensive de-interlacing or scaling algorithms.

Methods and apparatus described above select video processing algorithms to handle digital filtering tasks commensurate with the complexity of changing video scenes and available computing power. However, computing power available may also be variable. For example, the processor that performs video quality algorithms may be shared by multiple applications running on the same computer. Therefore, the processor may experience times when it is busy with many jobs and other times when it is relatively idle. Therefore, video processing algorithms may also be selected on the basis of computing power available at a particular time; in other words, in response to the load on a processor. When a processor is busy, less computationally intensive algorithms are selected compared to those selected when the processor is relatively idle.

Aspects of the invention described above may be implemented as functionality programmed into any of a variety of circuitry, including but not limited to electrically programmable logic and memory devices as well as application specific integrated circuits (ASICs) and fully custom integrated circuits. Some other possibilities for implementing aspects of the invention include: microcontrollers with memory (such as electronically erasable programmable read only memory (EEPROM)), embedded microprocessors, firmware, software, etc. Furthermore, aspects of the invention may be embodied in microprocessors having software-based circuit emulation, discrete logic (sequential and combinatorial), custom devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

As one skilled in the art will readily appreciate from the disclosure of the embodiments herein, processes, machines, manufacture, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, means, methods, or steps.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

In general, in the following claims, the terms used should not be construed to limit the systems and methods to the specific embodiments disclosed in the specification and the claims, but should be construed to include all systems that operate under the claims. Accordingly, the systems and methods are not limited by the disclosure, but instead the scope of the systems and methods are to be determined entirely by the claims.

What is claimed is:

1. A method for digital video filtering comprising:
pre-screening a digital video signal on a frame-by-frame basis;
selecting a filtering algorithm for each frame based on the results of the pre-screening; and,
filtering the video signal using the selected algorithm.

2. The method of claim 1 wherein pre-screening comprises using a motion detection method to detect and count the number of moving pixels in a video frame.

3. The method of claim 2 wherein the filtering algorithm is: a spatial algorithm, a spatial-temporal algorithm, a spatial-temporal algorithm with edge reconstruction, or a motion corrected algorithm.

4. The method of claim 1 wherein pre-screening comprises using an edge detection method to detect and count the number of edge pixels in a video frame.

5. The method of claim 4 wherein the filtering algorithm is a linear algorithm.

6. The method of claim 5 wherein the algorithm comprises: bilinear interpolation, bicubic interpolation, or interpolation with a kernel size greater than bicubic.

7. The method of claim 4 wherein the filtering algorithm is a non-linear algorithm.

8. The method of claim 7 wherein the algorithm is a content adaptive non-linear algorithm.

9. A method for digital video filtering comprising:
pre-screening a digital video signal on a frame-by-frame basis;
selecting a first filtering algorithm for a first region, and a second filtering algorithm for a second region, in each frame of the video signal based on the results of the pre-screening; and,
filtering the video signal using the selected algorithms.

10. The method of claim 9 wherein the regions are defined by a grid of tiles.

11. The method of claim 9 wherein the regions are areas of arbitrary shape within a video frame in which pre-screening has identified a large proportion of moving pixels compared to the other areas in the frame.

12. The method of claim 9 wherein the regions are areas of arbitrary shape within a video frame in which pre-screening has identified a large proportion of edge pixels compared to the other areas in the frame.

13. An apparatus for digital video filtering comprising:
a processing unit having a video input and a video output, said processing unit programmed to filter a digital video signal presented at the video input and provide results of filtering operations at the video output, wherein the processing unit pre-screens the digital video signal on a frame-by-frame basis, selects a filtering algorithm for each frame based on the results of the pre-screening, and filters the digital video signal using the selected algorithm.

14. The apparatus of claim 13 wherein selecting a filtering algorithm comprises selecting a first filtering algorithm for a first region, and a second filtering algorithm for a second region, in each frame of the digital video signal based on the results of the pre-screening, and wherein filtering the video signal comprises filtering the video signal using the selected algorithms.

15. The apparatus of claim 13 wherein pre-screening comprises using a motion detection method to detect and count the number of moving pixels in a video frame.

16. The apparatus of claim 15 wherein the filtering algorithm is: a spatial algorithm, a spatial-temporal algorithm, a spatial-temporal algorithm with edge reconstruction, or a motion corrected algorithm.

17. The apparatus of claim 13 wherein pre-screening comprises using an edge detection method to detect and count the number of edge pixels in a video frame.

18. The apparatus of claim 17 wherein the filtering algorithm comprises: bilinear interpolation, bicubic interpolation, or interpolation with a kernel size greater than bicubic.

19. The apparatus of claim 17 wherein the filtering algorithm is a non-linear content adaptive algorithm.

20. The apparatus of claim 17 wherein the algorithm is a mixture of linear and non-linear operations in both spatial and temporal domains.
